(19) United States
(12) Patent Application Publication
(10) Pub. No.: US 2026/0189492 A1
(43) Pub. Date: Jul. 2, 2026

(54) ENHANCED LINK CAPACITY ESTIMATION

(71) Applicant: QUALCOMM Incorporated, San Diego, CA (US)

(72) Inventors: Yann LEBRUN, Velizy-Villacoublay (FR); Simone MERLIN, San Diego, CA (US); Peerapol TINNAKORNSRISUPHAP, San Diego, CA (US); Mickael MONDET, Louannec (FR); Saadallah KASSIR, San Diego, CA (US); Yih-Hao LIN, San Diego, CA (US)

(21) Appl. No.: 19/005,914

(22) Filed: Dec. 30, 2024

(51) Int. Cl. H04L 43/0882; H04W 28/08

(52) U.S. Cl. CPC H04L 43/0882; H04W 28/08

(57) ABSTRACT

Methods, systems, and devices for wireless communications are described. A user equipment (UE) may transmit a request for link capacity information associated with a wireless channel for wireless communications between the UE and a network entity. The UE may receive a message indicating the link capacity information associated with the wireless channel. The UE may estimate a link capacity for the wireless channel in accordance with the link capacity information, wherein subsequent wireless communications are performed in accordance with the estimated link capacity.

### FIELD OF TECHNOLOGY

The following relates to wireless communications, including enhanced link capacity estimation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include transmitting a request for link capacity information associated with a wireless channel for wireless communications between the UE and a network entity, receiving a message indicating the link capacity information associated with the wireless channel, and estimating a link capacity for the wireless channel in accordance with the link capacity information, where subsequent wireless communications are performed in accordance with the estimated link capacity.

An apparatus for wireless communications at a UE is described. The apparatus may include one or more processors, one or more memories coupled with the one or more processors, and one or more processor-readable instructions stored in the one or more memories. The one or more processor-readable instructions may be executable by the one or more processors to individually or collectively to cause the apparatus to transmit a request for link capacity information associated with a wireless channel for wireless communications between the UE and a network entity, receive a message indicating the link capacity information associated with the wireless channel, and estimate a link capacity for the wireless channel in accordance with the link capacity information, where subsequent wireless communications are performed in accordance with the estimated link capacity.

Another UE for wireless communications is described. The UE may include means for transmitting a request for link capacity information associated with a wireless channel for wireless communications between the UE and a network entity, means for receiving a message indicating the link capacity information associated with the wireless channel, and means for estimating a link capacity for the wireless channel in accordance with the link capacity information, where subsequent wireless communications are performed in accordance with the estimated link capacity.

A non-transitory computer-readable medium storing code for wireless communications is described. The code may include instructions executable by one or more processors to transmit a request for link capacity information associated with a wireless channel for wireless communications between the UE and a network entity, receive a message indicating the link capacity information associated with the wireless channel, and estimate a link capacity for the wireless channel in accordance with the link capacity information, where subsequent wireless communications are performed in accordance with the estimated link capacity.

Some examples of the method, user equipment (UEs), apparatus, and non-transitory computer-readable medium described herein may further include operations, features, means, or instructions for identifying a starting frame associated with one or more packets to obtain frame-to-packet mapping information, where the estimated link capacity may be in accordance with the frame-to-packet mapping information.

Some examples of the method, user equipment (UEs), apparatus, and non-transitory computer-readable medium described herein may further include operations, features, means, or instructions for using the frame-to-packet mapping information to estimate a network load associated with the network entity, where the estimated link capacity may be in accordance with the estimated network load, using the frame-to-packet mapping information to estimate the link capacity within a packet delay budget, and using the frame-to-packet mapping information to estimate a dynamic burst interval parameters, where the link capacity may be in accordance with a dynamic burst interval parameter.

In some examples of the method, user equipment (UEs), apparatus, and non-transitory computer-readable medium described herein, the starting frame may be identified at a physical layer of the UE using time trace information associated with the one or more packets.

In some examples of the method, user equipment (UEs), apparatus, and non-transitory computer-readable medium described herein, the starting frame may be identified at an application in an application layer of the UE in accordance with the link capacity information.

Some examples of the method, user equipment (UEs), apparatus, and non-transitory computer-readable medium described herein may further include operations, features, means, or instructions for using a set of network traffic parameters corresponding to a time window to estimate network load information associated with the network entity, where the estimated link capacity may be in accordance with the network load information.

In some examples of the method, user equipment (UEs), apparatus, and non-transitory computer-readable medium described herein, the link capacity information identifies the set of network traffic parameters corresponding to the time window, a physical layer of the UE estimates the network load information using the link capacity information and outputs the network load information to an application at an application layer of the UE, and the application layer of the UE estimates the link capacity in accordance with the network load information.

In some examples of the method, user equipment (UEs), apparatus, and non-transitory computer-readable medium described herein, a physical layer of the UE outputs the set of network traffic parameters corresponding to the time window to an application at an application layer of the UE, the application at the application layer of the UE estimates the network load information using the set of network traffic parameters corresponding to the time window, and the application at the application layer of the UE estimates the link capacity in accordance with the network load information.

Some examples of the method, user equipment (UEs), apparatus, and non-transitory computer-readable medium described herein may further include operations, features, means, or instructions for using, at an artificial intelligence (AI) model, a set of network scheduling parameters associated with the UE to estimate the link capacity.

In some examples of the method, user equipment (UEs), apparatus, and non-transitory computer-readable medium described herein, the set of network scheduling parameters may be output from a physical layer of the UE to the AI model, the estimated link capacity may be output from the AI model to an application at an application layer of the UE, and the application uses the estimated link capacity for rate control adaptation operations for the subsequent wireless communications.

Some examples of the method, user equipment (UEs), apparatus, and non-transitory computer-readable medium described herein may further include operations, features, means, or instructions for using the link capacity information and a set of metrics associated with the subsequent wireless communications to estimate the link capacity.

In some examples of the method, user equipment (UEs), apparatus, and non-transitory computer-readable medium described herein, the set of metrics include one or more of a frame-to-packet mapping information, a set of traffic metrics associated with the subsequent wireless communications, and a quality-of-service (QoS) metric associated with the subsequent wireless communications.

In some examples of the method, user equipment (UEs), apparatus, and non-transitory computer-readable medium described herein, an application at an application layer of the UE uses the link capacity information obtained from a physical layer of the UE and a legacy-based link capacity estimation to estimate the link capacity, and the application at the application layer uses the estimated link capacity for rate control adaptation operations associated with the subsequent wireless communications in accordance with the set of metrics.

Some examples of the method, user equipment (UEs), apparatus, and non-transitory computer-readable medium described herein may further include operations, features, means, or instructions for transmitting a UE capability message indicating support for link capacity estimation in accordance with one or more types of link capacity information.

Some examples of the method, user equipment (UEs), apparatus, and non-transitory computer-readable medium described herein may further include operations, features, means, or instructions for receiving information identifying one or more threshold-based or event-based conditions associated with the UE transmitting the request for the link capacity information.

Some examples of the method, user equipment (UEs), apparatus, and non-transitory computer-readable medium described herein may further include operations, features, means, or instructions for receiving the message may be in accordance with an occurrence of at least one of the one or more threshold-based or event-based conditions.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports enhanced link capacity estimation in accordance with one or more aspects of the present disclosure.

FIG. 2 shows an example of a wireless communications system that supports enhanced link capacity estimation in accordance with one or more aspects of the present disclosure.

FIG. 3 shows an example of a wireless communications system that supports enhanced link capacity estimation in accordance with one or more aspects of the present disclosure.

FIG. 4 shows an example of a wireless communications system that supports enhanced link capacity estimation in accordance with one or more aspects of the present disclosure.

FIG. 5 shows an example of a wireless communications system that supports enhanced link capacity estimation in accordance with one or more aspects of the present disclosure.

FIG. 6 shows an example of a wireless communications system that supports enhanced link capacity estimation in accordance with one or more aspects of the present disclosure.

FIG. 7 shows an example of a wireless communications system that supports enhanced link capacity estimation in accordance with one or more aspects of the present disclosure.

FIG. 8 shows an example of a wireless communications system that supports enhanced link capacity estimation in accordance with one or more aspects of the present disclosure.

FIG. 9 shows an example of a swim diagram that supports enhanced link capacity estimation in accordance with one or more aspects of the present disclosure.

FIGS. 10 and 11 show block diagrams of devices that support enhanced link capacity estimation in accordance with one or more aspects of the present disclosure.

FIG. 12 shows a block diagram of a communications manager that supports enhanced link capacity estimation in accordance with one or more aspects of the present disclosure.

FIG. 13 shows a diagram of a system including a device that supports enhanced link capacity estimation in accordance with one or more aspects of the present disclosure.

FIGS. 14 through 16 show flowcharts illustrating methods that support enhanced link capacity estimation in accordance with one or more aspects of the present disclosure.

### DETAILED DESCRIPTION

Wireless networks may use link capacity estimation (LCE) techniques to estimate the maximum throughput that can be sustained between the network entity and user equipment (UE) for a period of time (e.g., during a time window of duration N milliseconds (ms)). The network may use the LCE as an input to the adaptive rate control algorithm, as an input to dynamic spatial compute (DSC) offload decisions, among others. However, such LCE techniques do not adapt well to all scenarios. For example, such LCE techniques may overestimate the true link capacity in some scenarios, which may lead to video stuttering among other issues. Another example may include such LCE techniques underestimating the true link capacity in other scenarios, which may lead to degraded video quality. Thus, improved LCE techniques are needed.

Accordingly, aspects of the techniques described herein provide an improved framework for enabling enhanced maximum throughput (e.g., LCE) estimation. For example, a UE may transmit a request for link capacity information to a network entity. The link capacity information may be associated with a wireless channel for wireless communications between the UE and a network entity. The UE may receive a message indicating the link capacity information associated with the wireless channel. The UE may estimate the link capacity for the wireless channel in accordance with the link capacity information. Accordingly, subsequent wireless communications may be performed in accordance with the estimated link capacity.

Particular aspects of the subject matter described in this disclosure can be implemented to realize one or more of the following potential advantages. For example, the techniques described herein improve the accuracy of the LCE operations performed by the UE. The techniques describe herein improves user experience by improving the accuracy of the achievable throughput at the application and reduced stuttering issues. The techniques described herein improves the user experience by optimizing the switching between local and remote computation (e.g., for extended reality (XR)-related computation services).

Aspects of the disclosure are initially described in the context of wireless communications systems. Aspects of the disclosure are further illustrated by and described with reference to apparatus diagrams, system diagrams, and flowcharts that relate to enhanced link capacity estimation.

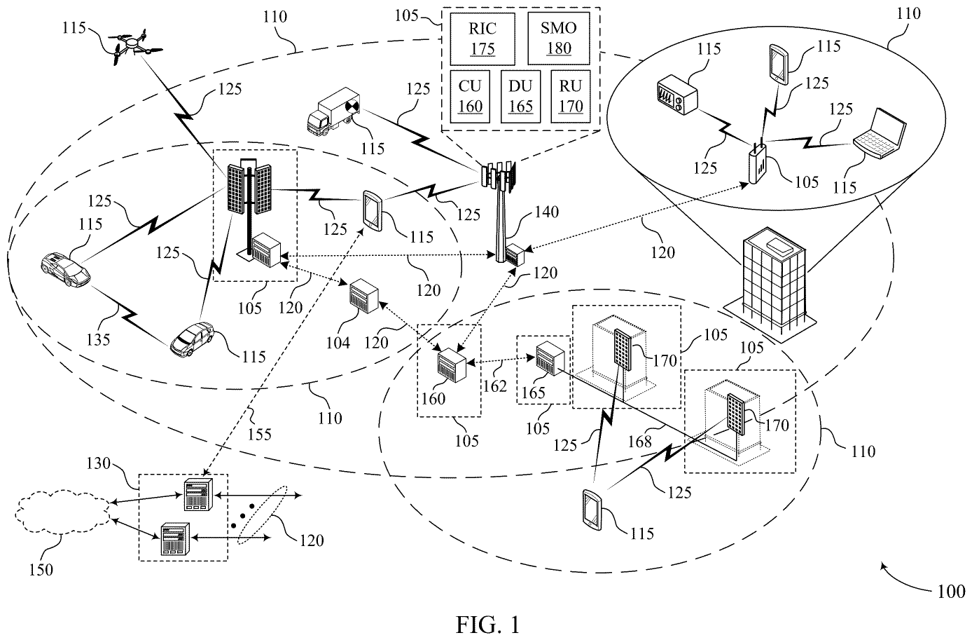

FIG. 1 shows an example of a wireless communications system 100 that supports enhanced link capacity estimation in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support enhanced link capacity estimation as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

A UE 115 may transmit a request for link capacity information associated with a wireless channel for wireless communications between the UE 115 and a network entity 105. The UE 115 may receive a message indicating the link capacity information associated with the wireless channel. The UE 115 may estimate a link capacity for the wireless channel in accordance with the link capacity information, wherein subsequent wireless communications are performed in accordance with the estimated link capacity.

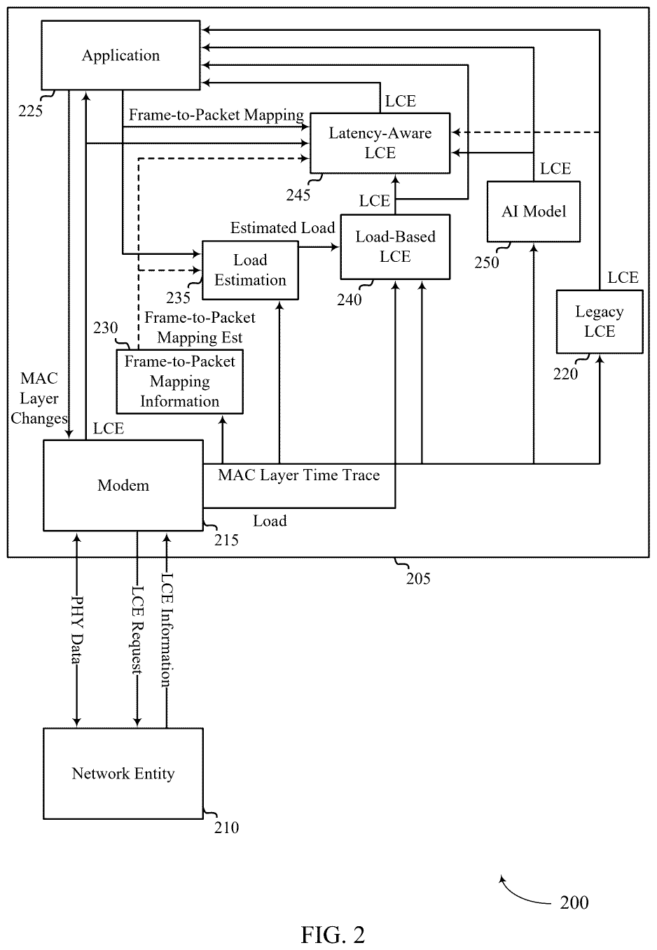

FIG. 2 shows an example of a wireless communications system 200 that supports enhanced link capacity estimation in accordance with one or more aspects of the present disclosure. The wireless communications system 200 may implement aspects of or be implemented by aspects of the wireless communications system 100. The wireless communications system 200 may include a UE 205 and a network entity 210, which may be examples of the corresponding devices described herein.

Wireless networks may define the link capacity of a wireless channel as the maximum throughput that can be sustained between the network and the UE 205. The knowledge of the link capacity may be useful as an input to adaptive rate control algorithms for extended reality (XR) applications, as an input to dynamic spatial compute (DSC) offload decisions for split rendering, among other uses. The XR compute-switching with dynamic spatial compute may include switching between remote computation where heavy processing tasks are offloaded to a rendering server and local computation (on-device processing) that is based on the estimated channel link capacity. For example, if the link capacity is too low and throughput requirements cannot be met then the processing may be switched to being done locally (e.g., local computation).

However, conventional LCE techniques have several limitations. One limitation includes the LCE operations being difficult to configure (e.g., several parameters that require configuration). Another limitation includes the LCE techniques being throughput dependent (e.g., a low throughput generates inaccurate estimation). This may prevent switching by DSC to offload computation, a cold start may make an accurate LCE difficult during the startup, and may prevent downward throughput spiral (e.g., a low throughput→low LCE→lower throughput→etc.). Another limitation includes a noisy case (e.g., requires smoothing which introduces a lag). Another limitation includes uninformed latency where the link capacity estimation must only consider data achievable within the packet delay budget (PDB). The goal of such conventional LCE techniques is to estimate the maximum throughput available on the downlink via the wireless channel.

However, techniques as described herein may offer improved performance relative to such legacy or conventional LCE techniques, such as improved performance for at least some operating scenarios. For example, such LCE techniques may overestimate the true link capacity in a scenario where the network is heavily loaded (e.g., in some resource utilization scenarios) which may lead to video stuttering. Such LCE techniques may underestimate the true link capacity in a scenario where the network is underloaded (e.g., in some resource utilization scenarios) which may lead to degraded video quality. Even when some hardcoded values (e.g., the burst interval, or Mu (μ), or others) are tuned specifically to an XR traffic class, techniques as described herein may offer improved adaptation (e.g., relative to conventional LCE techniques) for such wireless scenarios.

That is, some LCE techniques provide for a heuristic algorithm that may not adapt well to all scenarios. As one example, adjusting the burst interval value may partially correct such issues. For example, decreasing the burst interval value may give a smaller total burst duration which increases Cmax and may overestimate the LCE in some scenarios. Increasing the burst interval value may result in the total burst duration being likely to increase which decreases Cmax and may underestimate the LCE in some scenarios. If the burst interval is increased to improve the accuracy in scenarios with higher network loads this may result in accuracy issues in scenarios with lower network loads (e.g., there is no optimal value for burst interval value). Moreover, the burst interval may be dependent on the subband scheduling policy.

As another example, adjusting the value of Mu (μ) may fail to correct such issues. For example, increasing the value of Mu (μ) may result in the LCE algorithm favoring the lower bound Cmin which may decrease the accuracy in lower network load scenarios. Decreasing the value of Mu (μ) may result in the LCE algorithm favoring the upper bound Cmax which may decrease the accuracy in higher network load scenarios. Thus, Mu (μ) is increased there may be a gain in accuracy in one scenario while losing accuracy in the other scenario (e.g., there is not optimal value of Mu (μ)).

In some aspects, such legacy or conventional LCE techniques may utilize medium access control (MAC) layer time traces where the time trace(s) containing data such as the timestamp of the packet and the grant size are forwarded from a modem (e.g., at the physical (PHY) layer) as input to the legacy LCE algorithm. Based on the estimated channel link capacity the XR application may adjust the video encoding rate, thus changing the throughput requirements.

Accordingly, the techniques described herein provide for a framework for enabling enhanced maximum throughput (e.g., link capacity) estimation at the UE 205. For example, this may include the UE 205 transmitting or otherwise outputting (and the network entity 210 receiving or otherwise obtaining) a request for link capacity information associated with a wireless channel being used for wireless communications between the UE 205 and the network entity 210. The network entity 210 may transmit or otherwise output (and the UE 205 may receive or otherwise obtain) a message indicating or otherwise identifying the link capacity information associated with the wireless channel. The UE 205 may estimate the link capacity (e.g., an estimated link capacity) for the wireless channel in accordance with the link capacity information. For example, subsequent wireless communications between the UE 205 and the network entity 210 may be performed in accordance with the estimated link capacity. Wireless communications system 200 illustrates one example of a framework for such enhanced LCE techniques. That is, wireless communications system 200 illustrates an example of various components and signaling (e.g., between the UE 205 and the network entity 210) as well as signaling between the various components.

In some aspects, the components may be implemented or otherwise supported by the UE 205. As one example, the components may be implemented at or implemented according to application-modem X-layer application program interface (API) operably coupled to or otherwise in communication with various layers of the UE 205. For example, the UE 205 may include a modem 215 at a PHY layer that manages aspects of physical layer communications (e.g., PHY data) between the UE 205 and the network entity 210. The modem 215 may also be used for communicating the request for the link capacity information and response providing the link capacity information between the UE 205 and the network entity 210. The modem 215 may provide an output indicating or otherwise identifying the MAC layer time trace information to a legacy LCE 220, to a frame-to-packet mapping information 230, to a load estimation 235, and to a load-based LCE 240. The modem 215 may also provide an output indicating network load information to the load-based LCE 240. The modem 215 may provide an output identifying or otherwise indicating LCE (e.g., various link capacity information or an estimated LCE based on the link capacity information) to an application 225 and to a latency-aware LCE 245.

The legacy LCE 220 may obtain the MAC layer time trace information and estimate the link capacity (e.g., according to the techniques described above). The legacy LCE 220 may output the estimated LCE to the application 225 and to the latency-aware LCE 245. The frame-to-packet mapping information 230 may obtain the MAC layer time trace information and use this information to identify or otherwise determine an estimated frame-to-packet mapping information. The frame-to-packet mapping information 230 may output the estimated frame-to-packet mapping information to the load estimation 235 and to the latency-aware LCE 245.

The load estimation 235 may obtain the estimated frame-to-packet mapping information as well as frame-to-packet mapping information from the application 225 and use this information to identify or otherwise determine an estimation of the network load. The load estimation 235 may output the estimated network load information to the load-based LCE 240. The load-based LCE 240 may use the network load information obtained from the modem 215, the estimated network load information obtained from the load estimation 235 and the MAC layer time trace information obtained from the modem 215 to estimate the link capacity. The load-based LCE 240 may output the estimated link capacity to the latency-aware LCE 245 and to the application 225.

The AI model 250 may obtain the MAC layer time trace information from the modem 215 and estimate the link capacity. The AI model 250 may output the estimated link capacity to the latency-aware LCE 245 and to the application 225. The latency-aware LCE 245 may obtain the frame-to-packet mapping information from the application 225 and from the frame-to-packet mapping information 230, the estimated LCE from the load-based LCE 240 and from the estimated LCE from the AI model 250 and use this information to estimate the LCE. The latency-aware LCE 245 may output the estimated link capacity to the application 225.

Accordingly, the application 225 operating at an application layer of the UE 205 may receive the estimated link capacity (e.g., LCE) from the modem 215, from the legacy LCE 220, from the AI model 250, from the load-based LCE 240, and from the latency-aware LCE 245 and use this information to estimate the link capacity of the wireless channel. The application 225 may use the estimated link capacity to output to the modem 215 to change various MAC layer parameters or settings (e.g., MCS, frame rate, or other settings).

Thus, the components illustrated as part of the UE 205 provide various functionalities that monitor and use MAC layer time trace information, network load information, leverage AI modeling, and other features to provide a more robust LCE technique that adapts (e.g., in real-time or near real-time) to various network scenarios to provide a more accurate link capacity estimation. Additional features regarding the components implemented according to the techniques described herein are provided with respect to the below figures.

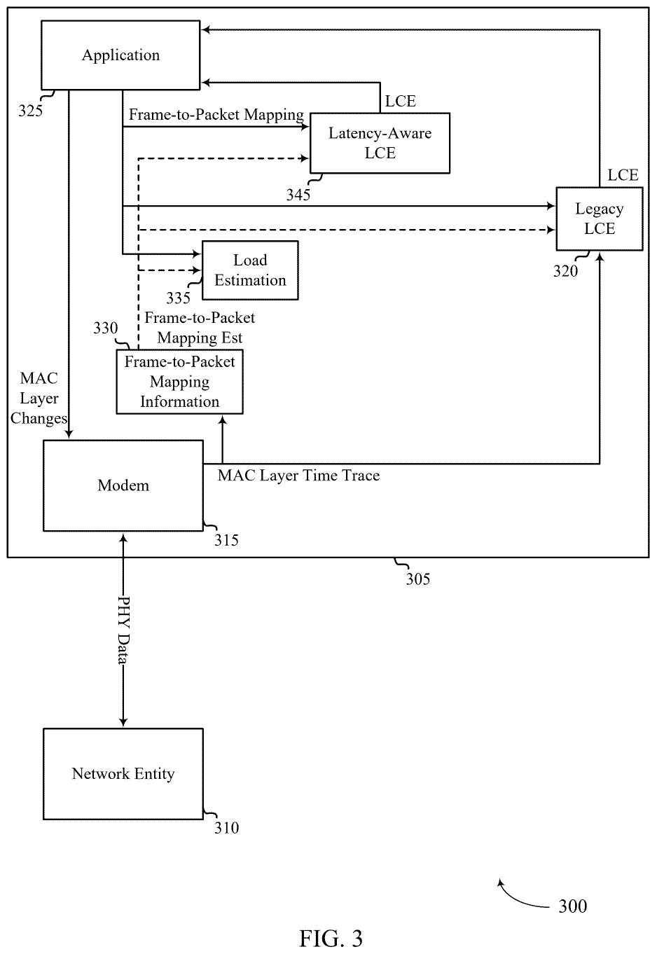

FIG. 3 shows an example of a wireless communications system 300 that supports enhanced link capacity estimation in accordance with one or more aspects of the present disclosure. The wireless communications system 300 may implement aspects of or be implemented by aspects of the wireless communications system 100 or the wireless communications system 200. The wireless communications system 300 may include a UE 305 and a network entity 310, which may be examples of the corresponding devices described herein.

As discussed above, aspects of the techniques described herein provide for a framework that enables enhanced maximum throughput (e.g., link capacity) estimation at the UE 305. The wireless communications system 300 highlights aspects of the different components and signaling (e.g., between the UE 305 and the network entity 310) as well as the signaling between the components. In some aspects, the components may be implemented within an Application-Modem X-layer API operating within the UE 305. For example, the UE 305 may transmit or otherwise output (and the network entity 310 may receive or otherwise obtain) a request for link capacity information associated with a wireless channel being used for wireless communications between the UE 305 and the network entity 310. In response, the network entity 310 may transmit or otherwise output (and the UE 305 may receive or otherwise obtain) a message that carries or otherwise conveys information indicating or otherwise identifying the link capacity information associated with the wireless channel. The UE 305 may estimate the link capacity (e.g., to obtain an estimated link capacity) in accordance with the link capacity information obtained from the network entity 310. Accordingly, subsequent wireless communications between the UE 305 and the network entity 310 may be performed in accordance with the estimated link capacity.

In the example shown in the wireless communications system 300, the components of the UE 305 that may implement aspects of the described techniques include a modem 315, a legacy LCE 320, an application 325, a frame-to-packet mapping information 330, a load estimation 335 and a latency-aware LCE 345.

The components of the UE 305 illustrated in wireless communications system 300 illustrate an example where the link capacity information includes or is otherwise associated with frame-to-packet mapping information. As one example, downlink XR traffic may include video frames that are transmitted at a specific frame rate (e.g., 60 frames per second). Each video frame may use one or more packets (e.g., MAC protocol data unit(s) (PDU(s))). The frame-to-packet mapping information may be used to identify the first packet of a new frame (e.g., a starting frame). For example, the UE may identify or otherwise determine a starting frame associated with one or more packets to obtain the frame-to-packet mapping information. The estimated link capacity may be in accordance with the frame-to-packet mapping information.

In some aspects, acquiring the indication of the start of a new frame may be achieved in different ways. One approach may include estimating the frame-to-packet mapping information at the UE side. For example, the starting frame may be identified at a physical layer of the UE using time trace information (e.g., MAC layer time trace information) associated with the one or more packets. In this algorithm-based approach, this may include applying statistical or machine-learning (ML) methods on the MAC time trace information to map each packet to the corresponding video frame. This technique may be applied to other periodic transmissions as well (e.g., such as audio traffic).

Another approach may be provided by the application 325 through the Application-Model X-Layer API signaling for mapping between the frames (e.g., application layer data) and the transport blocks (e.g., MAC layer data). For example, the starting frame may be identified at an application in the application layer of the UE 305 in accordance with the link capacity information. In this application-based approach, the application 325 may signal the start of each frame through API signaling or other types of metadata about the traffic. One example may include indicating the sequence number of the PDCP PDU containing the start of the frame or signaling a new application data unit (ADU).

Accordingly, in this example the modem 315 may provide the MAC layer time trace information to the frame-to-packet mapping information 330 as well as to the legacy LCE 320 to be used for frame-to-packet mapping information estimation or for LCE estimation, respectively. The frame-to-packet mapping information 330 may output the estimated frame-to-packet mapping information to the load estimation 335 to aid in load estimation and to the latency-aware LCE 345 to aid in LCE estimation. The latency-aware LCE 345 may output the estimated LCE to the application 325 and the legacy LCE 320 may output its estimated LCE to the application 325, which may use this information for improved LCE techniques. For example, the application 325 may identify or otherwise determine frame-to-packet mapping information and provide this information to the load estimation 335 and to the latency-aware LCE 345 for improved operations.

Thus, in this example the component(s) of the UE 305 may use the frame-to-packet mapping information to estimate a network load (e.g., at the load estimation 335) associated with the network entity 310. The estimated link capacity may be in accordance with the estimated network load. Thus, in this example the application 325 may signal (e.g., through the Application-Model X-Layer API) the frame-to-packet mapping (or the PDU-set information) to the load estimation 335. The load estimation 335 may use the frame-to-packet mapping information to estimate the network load at the UE side.

Additionally, or alternatively, in this example the component(s) of the UE 305 may use the frame-to-packet information to estimate the link capacity within a PDB. For example, the application 325 may signal the frame-to-packet mapping information (or the PDU-set information delay budget) to the latency-aware LCE 345. Accordingly, the link capacity estimated by the latency-aware LCE 345 and output to the application 325 may include LCE that is within the PDB limit.

Additionally, or alternatively, in this example the component(s) of the UE 305 may use the frame-to-packet mapping information to estimate a dynamic burst interval parameter(s). The link capacity may be estimated in accordance with the dynamic burst interval parameter(s). For example, the application 325 may signal the frame-to-packet mapping information to the legacy LCE 320 which may help link capacity estimation accuracy.

Thus, aspects of these techniques may be applied to the algorithm-based estimation approach when signaling is needed to share the information. For example, this may be helpful when the blocks (e.g., components) are located in separate entities, such as the frame-to-packet mapping is performed in the modem 315 and the load estimation is running on the digital signaling processing (DSP) or the neural processing unit (NPU) (e.g., at an application layer of the UE 305).

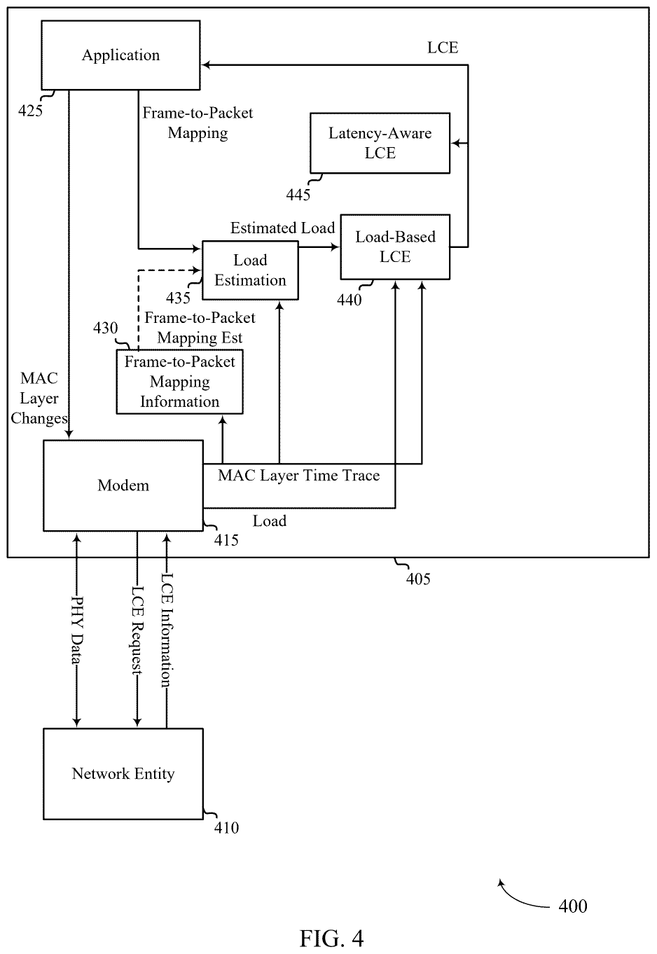

FIG. 4 shows an example of a wireless communications system 400 that supports enhanced link capacity estimation in accordance with one or more aspects of the present disclosure. The wireless communications system 400 may implement aspects of or be implemented by aspects of the wireless communications system 100, the wireless communications system 200, or the wireless communications system 300. The wireless communications system 400 may include a UE 405 and a network entity 410, which may be examples of the corresponding devices described herein.

As discussed above, aspects of the techniques described herein provide for a framework that enables enhanced maximum throughput (e.g., link capacity) estimation at the UE 405. The wireless communications system 400 highlights aspects of the different components and signaling (e.g., between the UE 405 and the network entity 410) as well as the signaling between the components. In some aspects, the components may be implemented within an Application-Modem X-layer API operating within the UE 405. For example, the UE 405 may transmit or otherwise output (and the network entity 410 may receive or otherwise obtain) a request for link capacity information associated with a wireless channel being used for wireless communications between the UE 405 and the network entity 410. In response, the network entity 410 may transmit or otherwise output (and the UE 405 may receive or otherwise obtain) a message that carries or otherwise conveys information indicating or otherwise identifying the link capacity information associated with the wireless channel. The UE 405 may estimate the link capacity (e.g., to obtain an estimated link capacity) in accordance with the link capacity information obtained from the network entity 410. Accordingly, subsequent wireless communications between the UE 405 and the network entity 410 may be performed in accordance with the estimated link capacity.

In the example shown in the wireless communications system 400, the components of the UE 405 that may implement aspects of the described techniques include a modem 415, an application 425, a frame-to-packet mapping information 430, a load estimation 435, a load-based LCE 440 and a latency-aware LCE 445.

The components of the UE 405 illustrated in wireless communications system 400 illustrate an example where the link capacity information includes or is otherwise associated with network traffic parameters. For example, the UE 405 may use the set of network traffic parameters corresponding to a time window to estimate network load information associated with the network entity 410. The estimated link capacity may be in accordance with the network load information.

In particular, aspects of the techniques described herein may use the number of slots used in a considered time window (e.g., num_slots_used). The radio frequency (RF) conditions are captured by the number of information bits in the aggregated slots (e.g., num_info_bits variable). The network load is exclusively captured by the load variable Mu (μ). Given the knowledge of the network load (e.g., Mu (μ)), a new formula may be used for link capacity estimation that is more reflective of the link capacity for all scenarios. The new formula may be defined according to:

$${C}_{max}^{new} = \frac{num\_info \_bits}{num\_slots \_used}$$

where the LCE is estimated according to:

$$LCE = {C}_{min} + ( 1 - μ ) {C}_{max}^{new}$$

Accordingly, the proposed algorithm uses the knowledge of the network load which can be provided through network signaling (e.g., in the link capacity information) or estimated at the UE-side (e.g., in the load estimation 435). For example, in some aspects the link capacity information may identify the set of network traffic parameters corresponding to the time window. The physical layer of the UE 405 (e.g., the modem 415) may estimate the network load information using the link capacity information and output the network load information to an application (e.g., the application 425) at an application layer of the UE 405. The application 425 may estimate the link capacity in accordance with the network load information.

Thus, in this example the load-based LCE 440 may signal to the application 425 (e.g., through the Application-Model X-Layer API) the new link capacity estimation that is based on the network load information. Moreover, the modem 415 may send the network load information to the load-based LCE 440 and the load-based LCE 440 may signal the latency-aware LCE 445 the new link capacity estimation.

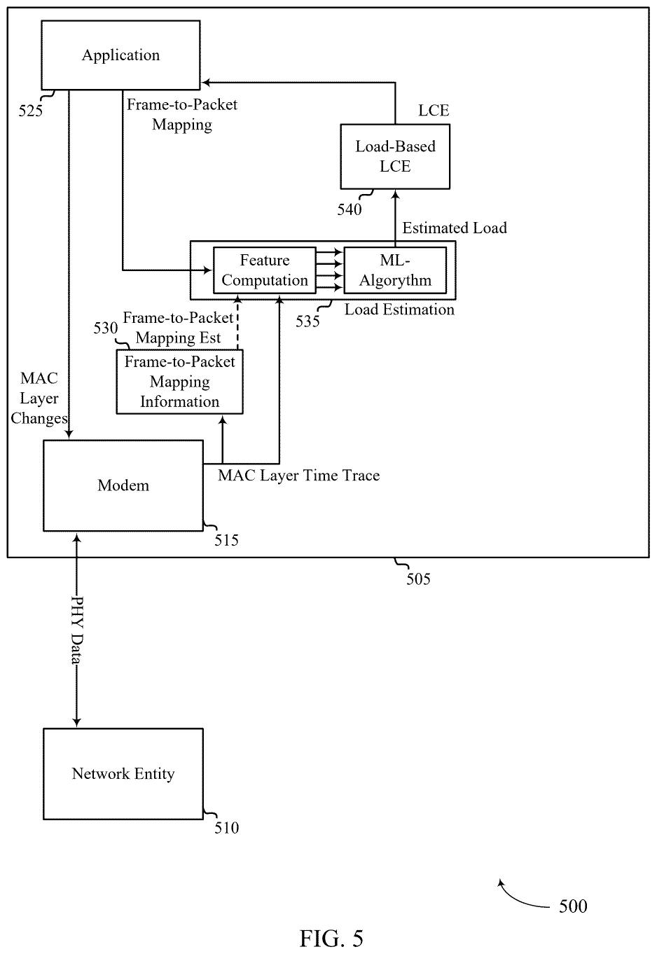

FIG. 5 shows an example of a wireless communications system 500 that supports enhanced link capacity estimation in accordance with one or more aspects of the present disclosure. The wireless communications system 500 may implement aspects of or be implemented by aspects of the wireless communications system 100, the wireless communications system 200, the wireless communications system 300, or the wireless communications system 400. The wireless communications system 500 may include a UE 505 and a network entity 510, which may be examples of the corresponding devices described herein.

As discussed above, aspects of the techniques described herein provide for a framework that enables enhanced maximum throughput (e.g., link capacity) estimation at the UE 505. The wireless communications system 500 highlights aspects of the different components and signaling (e.g., between the UE 505 and the network entity 510) as well as the signaling between the components. In some aspects, the components may be implemented within an Application-Modem X-layer API operating within the UE 505. For example, the UE 505 may transmit or otherwise output (and the network entity 510 may receive or otherwise obtain) a request for link capacity information associated with a wireless channel being used for wireless communications between the UE 505 and the network entity 510. In response, the network entity 510 may transmit or otherwise output (and the UE 505 may receive or otherwise obtain) a message that carries or otherwise conveys information indicating or otherwise identifying the link capacity information associated with the wireless channel. The UE 505 may estimate the link capacity (e.g., to obtain an estimated link capacity) in accordance with the link capacity information obtained from the network entity 510. Accordingly, subsequent wireless communications between the UE 505 and the network entity 510 may be performed in accordance with the estimated link capacity.

In the example shown in the wireless communications system 500, the components of the UE 505 that may implement aspects of the described techniques include a modem 515, an application 525, a frame-to-packet mapping information 530, a load estimation 535, and a load-based LCE 540.

The components of the UE 505 illustrated in wireless communications system 500 illustrate an example where the link capacity information includes or is otherwise associated with network traffic parameters. For example, the UE 505 may use the set of network traffic parameters corresponding to a time window to estimate network load information associated with the network entity 510. The estimated link capacity may be in accordance with the network load information.

In this example, the network load information may be estimated at the UE side (e.g., by the UE 505). For example, the physical layer of the UE 505 (e.g., the modem 515) may output the set of network traffic parameters corresponding to the time window to an application (e.g., the application 525) at an application layer of the UE 505. The application 525 may estimate the network load information using the set of network traffic parameters corresponding to the time window and estimate the link capacity in accordance with the network load information.

In some aspects, this may include the modem 515 providing the MAC layer time trace information to the load estimation 535. The load estimation 535 may exploit the MAC layer time trace information to estimate the level of the load at the network entity 510. For example, the load estimation 535 may compute a set of features and perform a machine-learning (ML)-based regression to predict the network load. Thus, in this example the load estimation 535 may include a feature computation component and a ML-algorithm component. The feature computation component may consider various features, such as the inter-frame arrival time (e.g., captures jitter in transmissions of the different XR frames), the intra-frame arrival time (e.g., captures intervals in the allocated receive resources frame-receive duration and exploits the correlation between the receive duration and network load), and the transport block size (e.g., helps distinguish traffic patterns from RF conditions vs traffic patterns resulting from the network load).

The ML-algorithm for network load estimation may be considered a regression model trained to map the input features to the ground truth network load. In some examples, this may include a low complexity algorithm (e.g., linear regression) that achieves an 8.4% mean error in load estimation accuracy.

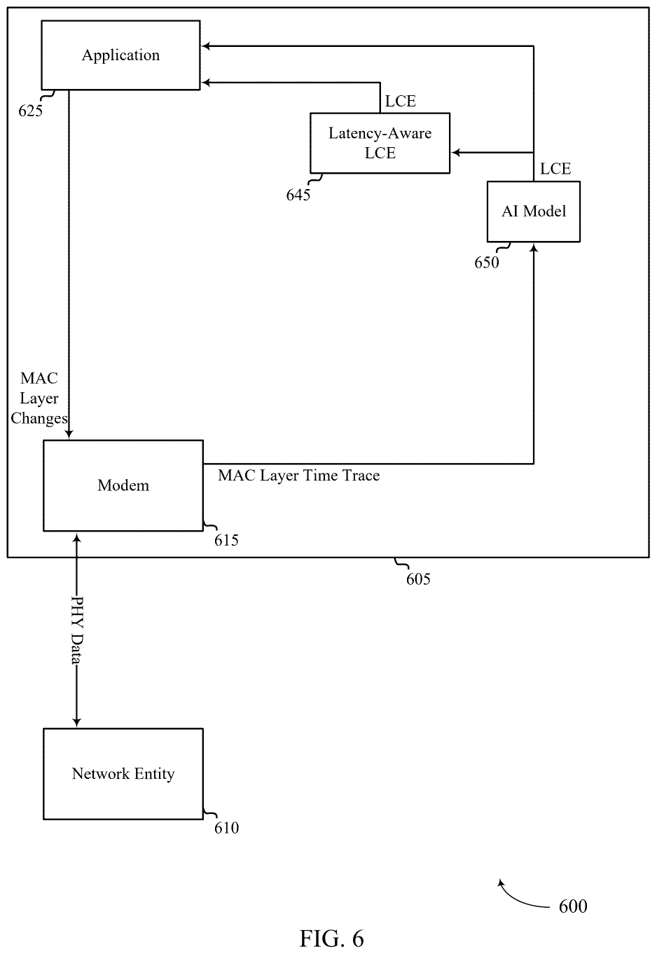

FIG. 6 shows an example of a wireless communications system 600 that supports enhanced link capacity estimation in accordance with one or more aspects of the present disclosure. The wireless communications system 600 may implement aspects of or be implemented by aspects of the wireless communications system 100, the wireless communications system 200, the wireless communications system 300, the wireless communications system 400, or the wireless communications system 500. The wireless communications system 600 may include a UE 605 and a network entity 610, which may be examples of the corresponding devices described herein.

As discussed above, aspects of the techniques described herein provide for a framework that enables enhanced maximum throughput (e.g., link capacity) estimation at the UE 605. The wireless communications system 600 highlights aspects of the different components and signaling (e.g., between the UE 605 and the network entity 610) as well as the signaling between the components. In some aspects, the components may be implemented within an Application-Modem X-layer API operating within the UE 605. For example, the UE 605 may transmit or otherwise output (and the network entity 610 may receive or otherwise obtain) a request for link capacity information associated with a wireless channel being used for wireless communications between the UE 605 and the network entity 610. In response, the network entity 610 may transmit or otherwise output (and the UE 605 may receive or otherwise obtain) a message that carries or otherwise conveys information indicating or otherwise identifying the link capacity information associated with the wireless channel. The UE 605 may estimate the link capacity (e.g., to obtain an estimated link capacity) in accordance with the link capacity information obtained from the network entity 610. Accordingly, subsequent wireless communications between the UE 605 and the network entity 610 may be performed in accordance with the estimated link capacity.

In the example shown in the wireless communications system 600, the components of the UE 605 that may implement aspects of the described techniques include a modem 615, an application 625, an AI model 650 and a latency-aware LCE 645.

The components of the UE 605 illustrated in wireless communications system 600 illustrate an example where the AI model (e.g., the AI model 650) uses a set of network scheduling parameters associated with the UE 605 to estimate the link capacity. For example, the set of network scheduling parameters may be output from a physical layer of the UE 605 (e.g., from the modem 615) to the AI model 650. That is, the modem 615 may provide the MAC layer time trace information to the AI model 650. The AI model 650 may estimate the link capacity (e.g., using the set of network scheduling parameters) and output the estimated link capacity to the application 625 at an application layer of the UE 605. For example, the generative AI algorithm may predict the number and timing of uplink and downlink grants, the MCS, and other related information, in the next N slots or milliseconds using an input prompt (e.g., the MAC layer time trace information). The input prompt may contain data available at the UE side (e.g., at the modem 615), such as the timing and size of downlink and uplink grants, the MCS, and rank. One example of an input prompt includes, but is not limited to, the PROMPT: r_c27 sle sle sle g_r3 g_m27 sle r_r3 r_c27 N-1 sle sle g_r3 g_m27 sle. This input prompt may be provided as input to the AI model 650. The corresponding ground truth for the next tokens may include: sle sle r_r3 r_c27 N-3 sle sle g_r3 g_m27 sle sle sle r_r3 r_c27 N-3 sle sle g_r3 g_m27 sle. The generative AI predicted values may include: sle sle r_r3 r_c27 N-3 sle sle g_r3 g_m27 sle sle sle r_r3 r_c27 A-3.

The generative AI algorithm (e.g., the AI model 650) may signal the application 625 (e.g., through the Application-Model X-Layer API) for rate control adaptation (e.g., for MAC layer changes). As the generative AI (e.g., the AI model 650) may be running on AI-dedicated hardware, the AI model 650 this may include signaling to share the LCE to the latency-aware LCE 645. The application 625 may use the estimated link capacity for rate control adaptation operations (e.g., MAC layer changes) for the subsequent wireless communications.

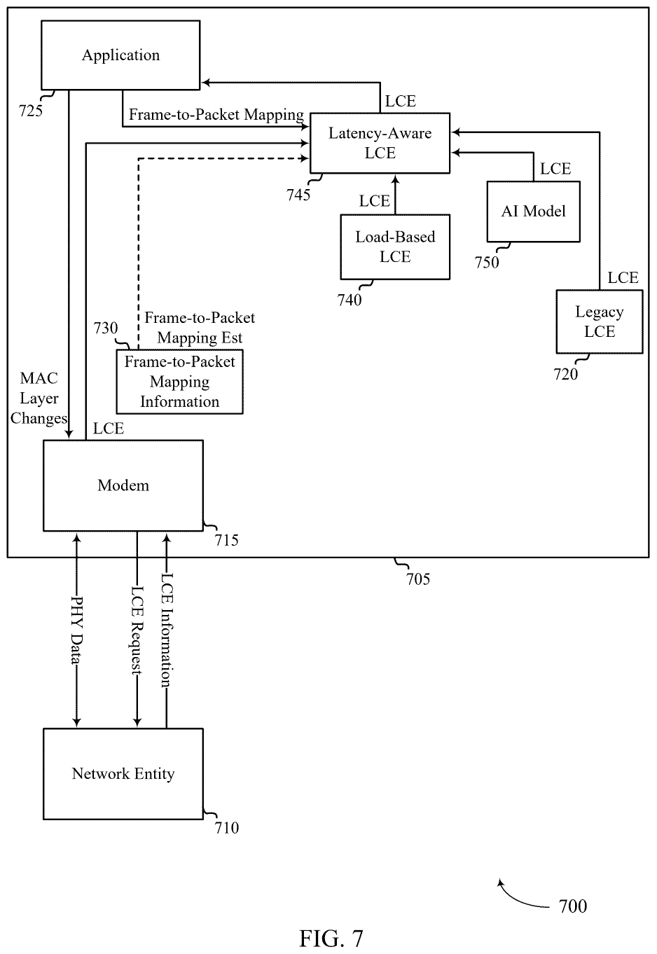

FIG. 7 shows an example of a wireless communications system 700 that supports enhanced link capacity estimation in accordance with one or more aspects of the present disclosure. The wireless communications system 700 may implement aspects of or be implemented by aspects of the wireless communications system 100, the wireless communications system 200, the wireless communications system 300, the wireless communications system 400, the wireless communications system 500, or the wireless communications system 600. The wireless communications system 700 may include a UE 705 and a network entity 710, which may be examples of the corresponding devices described herein.

As discussed above, aspects of the techniques described herein provide for a framework that enables enhanced maximum throughput (e.g., link capacity) estimation at the UE 705. The wireless communications system 700 highlights aspects of the different components and signaling (e.g., between the UE 705 and the network entity 710) as well as the signaling between the components. In some aspects, the components may be implemented within an Application-Modem X-layer API operating within the UE 705. For example, the UE 705 may transmit or otherwise output (and the network entity 710 may receive or otherwise obtain) a request for link capacity information associated with a wireless channel being used for wireless communications between the UE 705 and the network entity 710. In response, the network entity 710 may transmit or otherwise output (and the UE 705 may receive or otherwise obtain) a message that carries or otherwise conveys information indicating or otherwise identifying the link capacity information associated with the wireless channel. The UE 705 may estimate the link capacity (e.g., to obtain an estimated link capacity) in accordance with the link capacity information obtained from the network entity 710. Accordingly, subsequent wireless communications between the UE 705 and the network entity 710 may be performed in accordance with the estimated link capacity.

In the example shown in the wireless communications system 700, the components of the UE 705 that may implement aspects of the described techniques include a modem 715, a legacy LCE 720, an application 725, a frame-to-packet mapping information 730, a load-based LCE 740, a latency-aware LCE 745, and a AI model 750.

The components of the UE 705 illustrated in wireless communications system 700 illustrate an example where the link capacity information and a set of metrics associated with the subsequent wireless communications are used to estimate the link capacity. The set of metrics associated with the subsequent wireless communications may include, but are not limited to, frame-to-packet mapping information, a set of traffic metrics associated with the subsequent wireless communications, and a quality of service (QoS) metric associated with the subsequent wireless communications. That is, in this example the maximum throughput (e.g., the LCE) from the network entity 710 or from the load-based LCE 740 may not consider the PDB requirement. Instead, the adjusted LCE may include the link capacity information (e.g., from the network entity 710 or estimated by the UE 705) together with other inputs (e.g., the set of metrics) are processed to adjust the LCE to meet the latency requirements or other limitations. This may then be provided to the application 725 for rate control adaptation operations (e.g., for MAC layer changes).

For example, the AI model 750 may signal the LCE (e.g., the link control information received from the network entity 710) to the latency-aware LCE 745. The legacy LCE 720 algorithm may signal the latency-aware LCE 745 with the estimated link capacity. The latency-aware LCE 745 may signal the latency-adjusted LCE to the application 725 (e.g., through the Application-Model X-Layer API) for rate control adaptation operations. Accordingly, in this example the application 725 at the application layer of the UE 705 may use the link capacity information obtained from the physical layer of the UE 705 (e.g., obtained from the AI model 750) and a legacy-based link capacity estimation to estimate the link capacity. The application 725 may use the estimated link capacity for rate control adaptation operations associated with the subsequent wireless communications in accordance with the set of metrics.

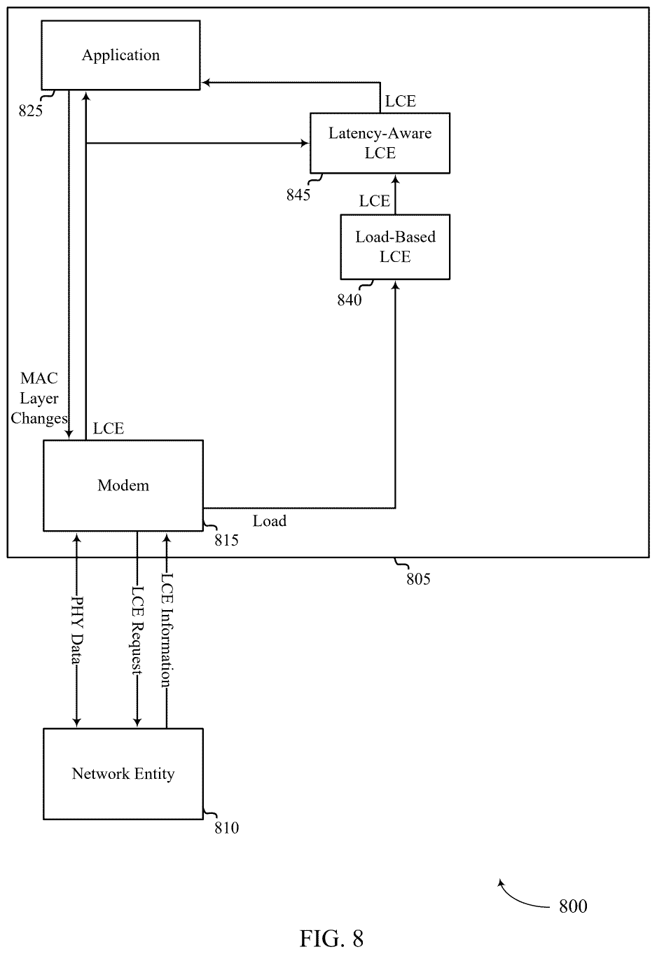

FIG. 8 shows an example of a wireless communications system 800 that supports enhanced link capacity estimation in accordance with one or more aspects of the present disclosure. The wireless communications system 800 may implement aspects of or be implemented by aspects of the wireless communications system 100, the wireless communications system 200, the wireless communications system 300, the wireless communications system 400, the wireless communications system 500, the wireless communications system 600, or the wireless communications system 700. The wireless communications system 800 may include a UE 805 and a network entity 810, which may be examples of the corresponding devices described herein.

As discussed above, aspects of the techniques described herein provide for a framework that enables enhanced maximum throughput (e.g., link capacity) estimation at the UE 805. The wireless communications system 800 highlights aspects of the different components and signaling (e.g., between the UE 805 and the network entity 810) as well as the signaling between the components. In some aspects, the components may be implemented within an Application-Modem X-layer API operating within the UE 805. For example, the UE 805 may transmit or otherwise output (and the network entity 810 may receive or otherwise obtain) a request for link capacity information associated with a wireless channel being used for wireless communications between the UE 805 and the network entity 810. In response, the network entity 810 may transmit or otherwise output (and the UE 805 may receive or otherwise obtain) a message that carries or otherwise conveys information indicating or otherwise identifying the link capacity information associated with the wireless channel. The UE 805 may estimate the link capacity (e.g., to obtain an estimated link capacity) in accordance with the link capacity information obtained from the network entity 810. Accordingly, subsequent wireless communications between the UE 805 and the network entity 810 may be performed in accordance with the estimated link capacity.

In the example shown in the wireless communications system 800, the components of the UE 805 that may implement aspects of the described techniques include a modem 815, an application 825, a load-based LCE 840, and a latency-aware LCE 845.

The components of the UE 805 illustrated in wireless communications system 800 illustrate an example using network-based signaling where, with the signaling, the network entity 810 shares the link capacity information data with the UE 805. The link capacity information shared with the UE 805 may include the network resource utilization percentage, physical downlink control channel (PDCCH) statistics, or other related information. The enable the LCE-related data sharing this may include enabling signaling between the UE 805 and the network entity 810.

In some aspects, this may include the UE 805 signaling or otherwise informing the network entity 810 that it supports LCE information. For example, the UE 805 may transmit or otherwise output (and the network entity 810 may receive or otherwise obtain) a UE capability message indicating support for link capacity estimation in accordance with one or more types of link capacity information. That is, the message from the UE 805 may include a type of LCE-related information that the UE 805 supports (e.g., link capacity, network resource utilization, PDCCH or physical uplink control channel (PUCCH) usage, and other related information types).

In some aspects, this may include the network optionally replying to the UE 805 to inform the condition(s) or event(s) for the UE 805 to send a MAC-control element (CE) for the LCE requests. For example, the network entity 810 may transmit or otherwise output (and the UE 805 may receive or otherwise obtain) information identifying one or more threshold-based or event-based conditions associated with the UE 805 transmitting the request for the link capacity information.

In some aspects, this may optionally include the network sending the LCE information to the UE 805 based on the event or threshold conditions occur (e.g., such as when detecting a change in the LCE value). Thus, in some aspects the UE 805 receiving the message indicating the link capacity information may be based on the occurrence of at least one of the threshold-based or event-based conditions.

As discussed above, the modem 815 may share aspects of the link capacity information with the application 825, with the load-based LCE 840, and with the latency-aware LCE 845. The load-based LCE 840 may use the link capacity information to estimate the network load and estimate the LCE based on the network load. The load-based LCE 840 may share the estimated link capacity with the latency-aware LCE 845 which may also estimate the link capacity using this information. The latency-aware LCE 845 may output the estimated link capacity to the application 825 accordingly, which may use the estimated link capacity for various rate adaptation operations (e.g., MAC layer changes).

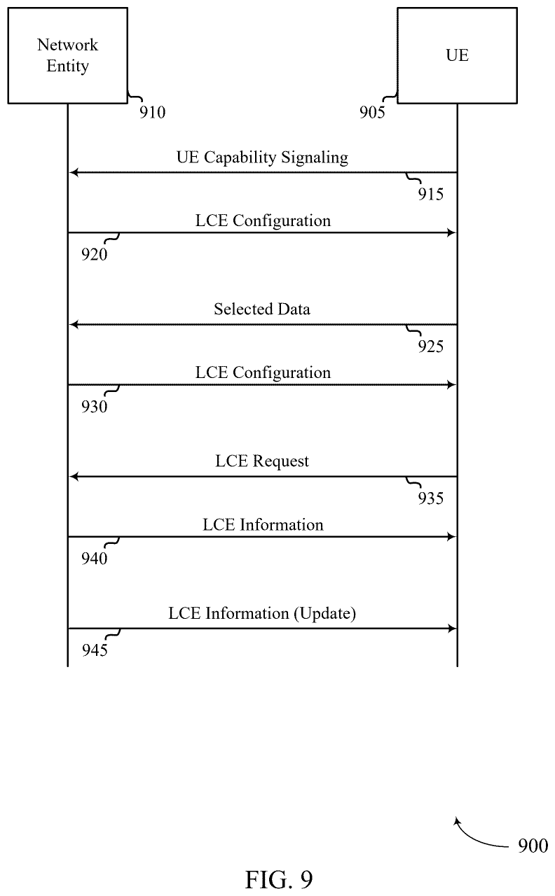

FIG. 9 shows an example of a swim diagram 900 that supports enhanced link capacity estimation in accordance with one or more aspects of the present disclosure. The swim diagram 900 may implement aspects of or be implemented by aspects of the wireless communications system 100, the wireless communications system 200, the wireless communications system 300, the wireless communications system 400, the wireless communications system 500, the wireless communications system 600, the wireless communications system 700, or the wireless communications system 800. Aspects of the swim diagram 900 may be implemented at or implemented by a UE 905 or a network entity 910, which may be examples of the corresponding devices described herein.

At 915, the UE 905 may transmit or otherwise output (and the network entity 910 may receiver or otherwise obtain) a UE capability message. The UE capability message may carry or otherwise convey information indicating that the UE 905 supports link capacity estimation. For example, the UE 905 may inform the network entity 910 that it supports LCE information. The UE 905 may signal (e.g., through RRC-based UE capability signaling) its support for LCE information.

At 920, the network entity 910 may transmit or otherwise output (and the UE 905 may receive or otherwise obtain) LCE configuration signaling. In some aspects, this may include the network entity 910 signaling (e.g., through a RRC connection reconfiguration message) an LCE configuration. The LCE information may inform the UE 905 of the types of data it can collect and share (e.g., link capacity information, network resource utilization, PDCCH usage statistics, and other related information).

At 925, the UE 905 may transmit or otherwise output (and the network entity 910 may receive or otherwise obtain) selected data. For example, the UE 905 may select the network resource utilization data to be used for LCE operations at the UE 905. The UE 905 may signal (e.g., through RRC-based UE capability information messaging) the selected data it can use for the LCE operations.

At 930, the network entity 910 may transmit or otherwise output (and the UE 905 may receive or otherwise obtain) LCE configuration information. For example, the network entity 910 may configure for the UE 905 the set(s) of conditions or events for the UE 905 to send LCE request(s) (e.g., such as a change in the RSRP, a prohibit timer, or other condition or event). Thus, the network entity 910 may signal (e.g., through RRC connection reconfiguration messaging) the LCE configuration to the UE 905.

At 935, the UE 905 may transmit or otherwise output (and the network entity 910 may receive or otherwise obtain) an LCE request. The LCE request may include a request for link capacity information associated with the wireless channel being used for wireless communications between the UE 905 and the network entity 910. In some cases, the LCE request may be in response to an occurrence of the event or condition previously configured in the LCE configuration. For example, the UE 905 may detect a change in the QoS (e.g., XR traffic) and request the LCE information in response. In some aspects, the UE 905 may signal the LCE request to the network entity 910 through MAC-CE or uplink control information (UCI) signaling.

At 940, the network entity 910 may transmit or otherwise output (and the UE 905 may receive or otherwise obtain) the LCE information (e.g., the link capacity information) associated with the wireless channel. For example, the network entity 910 may compute the LCE information in response to the LCE request and provide the computed LCE information to the UE 905. In some aspects, the network entity 910 may signal the LCE information to the UE 905 through MAC-CE or DCI signaling.

At 945, the network entity 910 may transmit or otherwise output (and the UE 905 may receive or otherwise obtain) updated LCE information. For example, the network entity 910 may detect a change in link capacity for the UE 905 (e.g., a 10% decrease in downlink link capacity), or a change in the network load (e.g., a load increase by 0.1 points), or in PDCCH statistics, or reaching a timer limit (e.g., 2,000 ms) for sending and update and inform the UE 905 of the updated LCE information. In some aspects, the network entity 910 may signal the updated LCE information to the UE 905 through MAC-CE or DCI signaling. The UE 905 may update its LCE operations using the updated LCE information obtained from the network entity 910.

Accordingly, the swim diagram 900 illustrates a non-limiting example of signaling that includes UE capability signaling (e.g., RRC messages), adding LCE configuration information into a RRC reconfiguration message, MAC-CE and UCI configuration for indicating the LCE request, as well as MAC-CE and DCI signaling for sending the LCE information.

For example, this may include RRC-related signaling changes including new signaling that includes adding LCE configuration information in RRC reconfiguration messages, including the type of data supported by the network entity 910. For example, the changes may include an observation window length (obsWindowLen) parameter that corresponds to the time window duration for computing the LCE information with a range from [5, 2000] ms (int8). The changes may include a link capacity downlink (linkCapacityDL) and a link capacity uplink (linkCapacityUL) parameter that corresponds to the downlink and uplink link capacity estimates with a range from [0, 1000] Mbps (int8). The changes may include a network load downlink (gNBLoadDL) and a network load uplink (gNBLoadUL) parameter that corresponds to the information about the cell load for the downlink and the uplink with a range from [0, 100]% (int4).

The changes may include a PUCCH statistics/physical uplink shared channel (PUSCH) statistics (pucchStats/puschStats) parameter that corresponds to the usage statistics for the control channel, for both uplink and downlink, with a range from [0, 100]% (int4). The changes may include an available LCE statistics (availableLCEstats) parameter that corresponds to a binary representation of the LCE data available with a range from [0, 15] (int4).

In some aspects, the RRC-related changes may include new fields being used to set the criteria for LCE-capable UE to request the LCE from the network entity 910. The changes may include an offset RSRP range (offsetRSRPrange) parameter that corresponds to allowing the request when the RSRP changes by the +/−offsetRSRPrange in dB with a range of [0, 30] dB (int4). The changes may include an on QoS change (onQosChange) parameter that corresponds to allowing the request when the traffic QoS changes with a range of True/False (binary). The change may include a prohibit timer (prohibitTimer) parameter that corresponds to the minimum delay between two LCE request with a range of [0, 1000] ms (int4).

For the MAC-CE related changes, this may include an uplink MAC-CE being used for the UE requests for the LCE feedback (e.g., the request for the link capacity information). This may include a downlink MAC-CE being used for the network entity 910 to share the LCE information.

For the UCI/DCI related changes, this may include the UE requests for LCE feedback going through the UCI messages. This may include the network entity 910 LCE-related DCI messages being used.

Accordingly, the techniques described herein provide for new methods to enhance the accuracy of the LCE at the UE side. The UE may exploit information available at the UE side only or based on network signaling to enhance the link capacity estimation. In some aspects, the signaling may include new signaling between the network entity 910 and the UE 905 to setup and share LCE-related information (e.g., via MAC-CE or RRC signaling). This may include new signaling between the application and the algorithm for mapping between the Frames (application layer data) and transport blocks (MAC layer data).

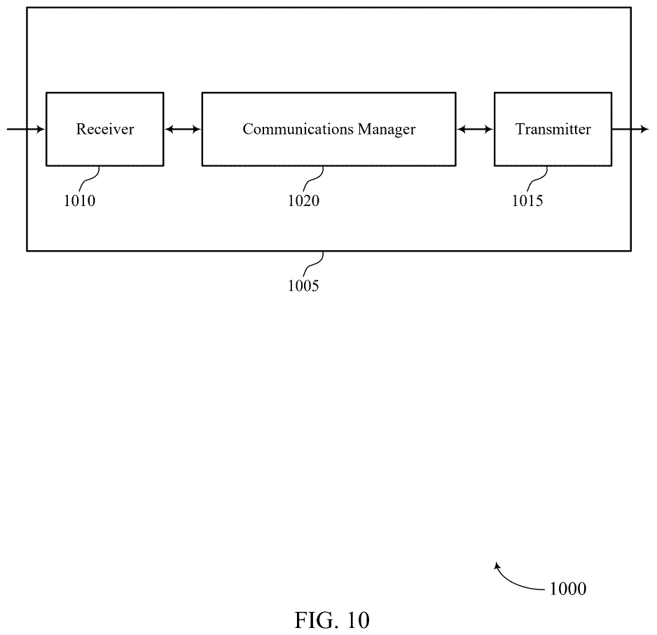

FIG. 10 shows a block diagram 1000 of a device 1005 that supports enhanced link capacity estimation in accordance with one or more aspects of the present disclosure. The device 1005 may be an example of aspects of a UE 115 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for receiving information such as packets, user data, control information, or any combination thereof associated with various information channels (e.g., control channels, data channels, information channels related to enhanced link capacity estimation). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to enhanced link capacity estimation). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations or components thereof may be examples of means for performing various aspects of enhanced link capacity estimation as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for transmitting a request for link capacity information associated with a wireless channel for wireless communications between the UE and a network entity. The communications manager 1020 is capable of, configured to, or operable to support a means for receiving a message indicating the link capacity information associated with the wireless channel. The communications manager 1020 is capable of, configured to, or operable to support a means for estimating a link capacity for the wireless channel in accordance with the link capacity information, where subsequent wireless communications are performed in accordance with the estimated link capacity.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for an enhanced LCE calculation and update procedure between the UE and the network. The described techniques may use UE-based information, network-signaled information, or both, to update the link capacity estimation operations performed by the UE.

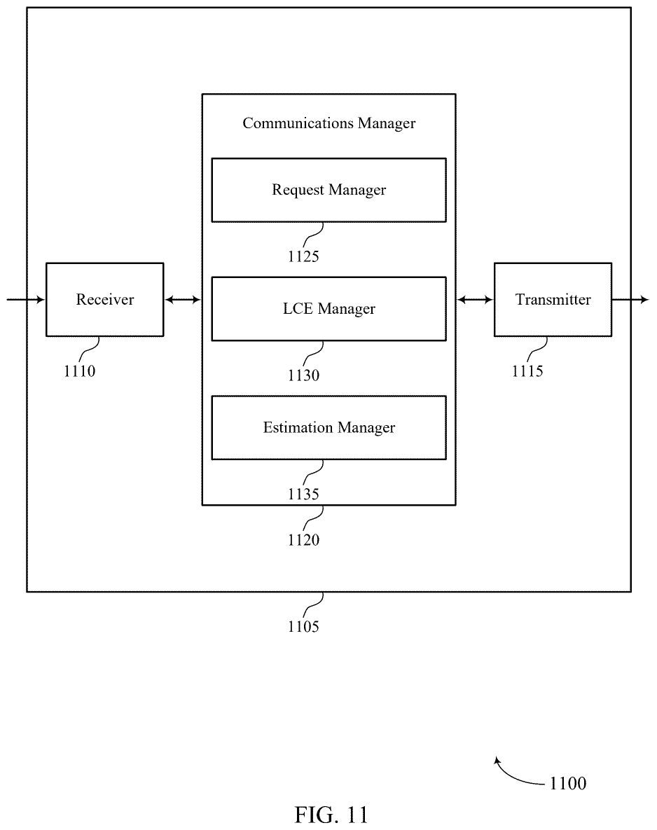

FIG. 11 shows a block diagram 1100 of a device 1105 that supports enhanced link capacity estimation in accordance with one or more aspects of the present disclosure. The device 1105 may be an example of aspects of a device 1005 or a UE 115 as described herein. The device 1105 may include a receiver 1110, a transmitter 1115, and a communications manager 1120. The device 1105, or one of more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for receiving information such as packets, user data, control information, or any combination thereof associated with various information channels (e.g., control channels, data channels, information channels related to enhanced link capacity estimation). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to enhanced link capacity estimation). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of enhanced link capacity estimation as described herein. For example, the communications manager 1120 may include a request manager 1125, an LCE manager 1130, an estimation manager 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The request manager 1125 is capable of, configured to, or operable to support a means for transmitting a request for link capacity information associated with a wireless channel for wireless communications between the UE and a network entity. The LCE manager 1130 is capable of, configured to, or operable to support a means for receiving a message indicating the link capacity information associated with the wireless channel. The estimation manager 1135 is capable of, configured to, or operable to support a means for estimating a link capacity for the wireless channel in accordance with the link capacity information, where subsequent wireless communications are performed in accordance with the estimated link capacity.

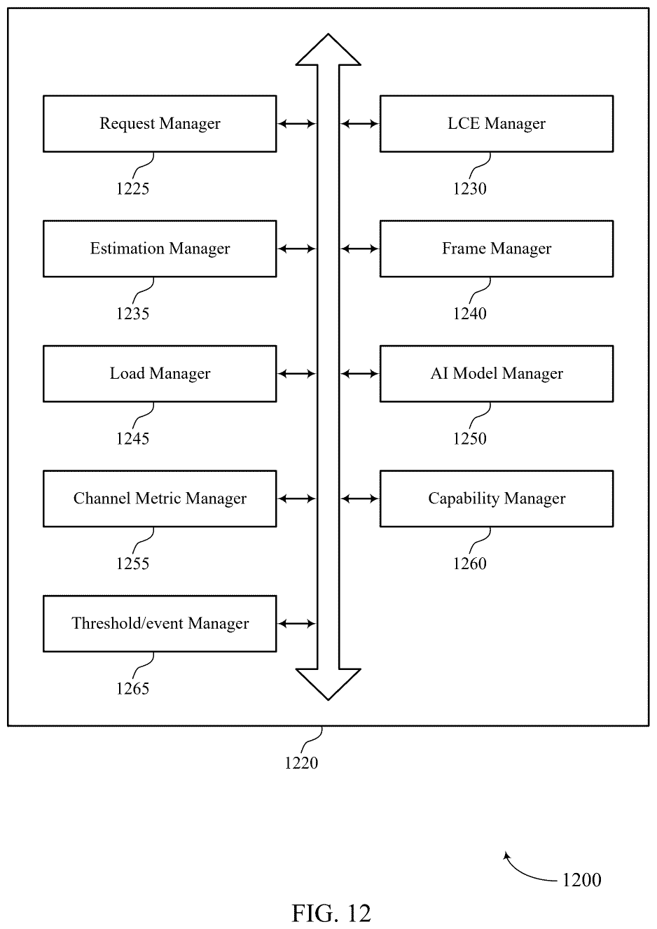

FIG. 12 shows a block diagram 1200 of a communications manager 1220 that supports enhanced link capacity estimation in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of enhanced link capacity estimation as described herein. For example, the communications manager 1220 may include a request manager 1225, an LCE manager 1230, an estimation manager 1235, a frame manager 1240, a load manager 1245, an AI model manager 1250, a channel metric manager 1255, a capability manager 1260, a threshold/event manager 1265, or any combination thereof. Each of these components, or components or subcomponents thereof (e.g., one or more processors, one or more memories), may communicate, directly or indirectly, with one another (e.g., via one or more buses).

The communications manager 1220 may support wireless communications in accordance with examples as disclosed herein. The request manager 1225 is capable of, configured to, or operable to support a means for transmitting a request for link capacity information associated with a wireless channel for wireless communications between the UE and a network entity. The LCE manager 1230 is capable of, configured to, or operable to support a means for receiving a message indicating the link capacity information associated with the wireless channel. The estimation manager 1235 is capable of, configured to, or operable to support a means for estimating a link capacity for the wireless channel in accordance with the link capacity information, where subsequent wireless communications are performed in accordance with the estimated link capacity.

In some examples, the frame manager 1240 is capable of, configured to, or operable to support a means for identifying a starting frame associated with one or more packets to obtain frame-to-packet mapping information, where the estimated link capacity is in accordance with the frame-to-packet mapping information.

In some examples, the frame manager 1240 is capable of, configured to, or operable to support a means for using the frame-to-packet mapping information to estimate a network load associated with the network entity, where the estimated link capacity is in accordance with the estimated network load. In some examples, the frame manager 1240 is capable of, configured to, or operable to support a means for using the frame-to-packet mapping information to estimate the link capacity within a packet delay budget. In some examples, the frame manager 1240 is capable of, configured to, or operable to support a means for using the frame-to-packet mapping information to estimate a dynamic burst interval parameters, where the link capacity is in accordance with a dynamic burst interval parameter. In some examples, the starting frame is identified at a physical layer of the UE using time trace information associated with the one or more packets. In some examples, the starting frame is identified at an application in an application layer of the UE in accordance with the link capacity information.

In some examples, the load manager 1245 is capable of, configured to, or operable to support a means for using a set of network traffic parameters corresponding to a time window to estimate network load information associated with the network entity, where the estimated link capacity is in accordance with the network load information.

In some examples, the link capacity information identifies the set of network traffic parameters corresponding to the time window, a physical layer of the UE estimates the network load information using the link capacity information and outputs the network load information to an application at an application layer of the UE, and the application layer of the UE estimates the link capacity in accordance with the network load information. In some examples, a physical layer of the UE outputs the set of network traffic parameters corresponding to the time window to an application at an application layer of the UE, the application at the application layer of the UE estimates the network load information using the set of network traffic parameters corresponding to the time window, and the application at the application layer of the UE estimates the link capacity in accordance with the network load information.

In some examples, the AI model manager 1250 is capable of, configured to, or operable to support a means for using, at an AI model, a set of network scheduling parameters associated with the UE to estimate the link capacity. In some examples, the set of network scheduling parameters are output from a physical layer of the UE to the AI model, the estimated link capacity is output from the AI model to an application at an application layer of the UE, and the application uses the estimated link capacity for rate control adaptation operations for the subsequent wireless communications.

In some examples, the channel metric manager 1255 is capable of, configured to, or operable to support a means for using the link capacity information and a set of metrics associated with the subsequent wireless communications to estimate the link capacity. In some examples, the set of metrics include one or more of a frame-to-packet mapping information, a set of traffic metrics associated with the subsequent wireless communications, and a QoS metric associated with the subsequent wireless communications. In some examples, an application at an application layer of the UE uses the link capacity information obtained from a physical layer of the UE and a legacy-based link capacity estimation to estimate the link capacity, and the application at the application layer uses the estimated link capacity for rate control adaptation operations associated with the subsequent wireless communications in accordance with the set of metrics.

In some examples, the capability manager 1260 is capable of, configured to, or operable to support a means for transmitting a UE capability message indicating support for link capacity estimation in accordance with one or more types of link capacity information.

In some examples, the threshold/event manager 1265 is capable of, configured to, or operable to support a means for receiving information identifying one or more threshold-based or event-based conditions associated with the UE transmitting the request for the link capacity information. In some examples, receiving the message is in accordance with an occurrence of at least one of the one or more threshold-based or event-based conditions.

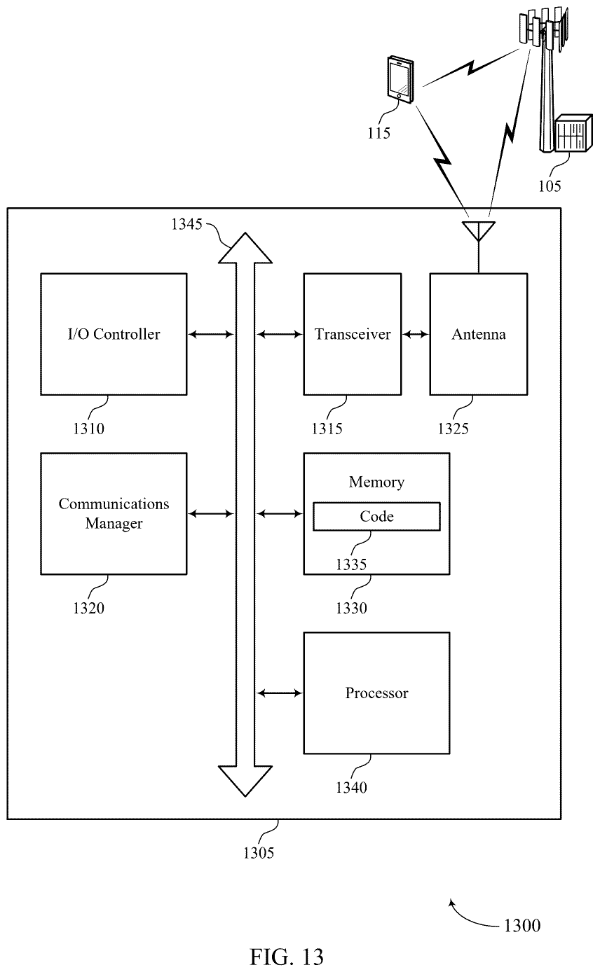

FIG. 13 shows a diagram of a system 1300 including a device 1305 that supports enhanced link capacity estimation in accordance with one or more aspects of the present disclosure. The device 1305 may be an example of or include components of a device 1005, a device 1105, or a UE 115 as described herein. The device 1305 may communicate (e.g., wirelessly) with one or more other devices (e.g., network entities 105, UEs 115, or a combination thereof). The device 1305 may include components for bi-directional voice and data communications including components for transmitting and receiving communications, such as a communications manager 1320, an input/output (I/O) controller, such as an I/O controller 1310, a transceiver 1315, one or more antennas 1325, at least one memory 1330, code 1335, and at least one processor 1340. These components may be in electronic communication or otherwise coupled (e.g., operatively, communicatively, functionally, electronically, electrically) via one or more buses (e.g., a bus 1345).

The I/O controller 1310 may manage input and output signals for the device 1305. The I/O controller 1310 may also manage peripherals not integrated into the device 1305. In some cases, the I/O controller 1310 may represent a physical connection or port to an external peripheral. In some cases, the I/O controller 1310 may utilize an operating system such as iOS®, ANDROID®, MS-DOS®, MS-WINDOWS®, OS/2®, UNIX®, LINUX®, or another known operating system. Additionally, or alternatively, the I/O controller 1310 may represent or interact with a modem, a keyboard, a mouse, a touchscreen, or a similar device. In some cases, the I/O controller 1310 may be implemented as part of one or more processors, such as the at least one processor 1340. In some cases, a user may interact with the device 1305 via the I/O controller 1310 or via hardware components controlled by the I/O controller 1310.

In some cases, the device 1305 may include a single antenna. However, in some other cases, the device 1305 may have more than one antenna, which may be capable of concurrently transmitting or receiving multiple wireless transmissions. The transceiver 1315 may communicate bi-directionally via the one or more antennas 1325 using wired or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The at least one memory 1330 may include random access memory (RAM) and read-only memory (ROM). The at least one memory 1330 may store computer-readable, computer-executable, or processor-executable code, such as the code 1335. The code 1335 may include instructions that, when executed by the at least one processor 1340, cause the device 1305 to perform various functions described herein. The code 1335 may be stored in a non-transitory computer-readable medium such as system memory or another type of memory. In some cases, the code 1335 may not be directly executable by the at least one processor 1340 but may cause a computer (e.g., when compiled and executed) to perform functions described herein. In some cases, the at least one memory 1330 may include, among other things, a basic I/O system (BIOS) which may control basic hardware or software operation such as the interaction with peripheral components or devices.

The at least one processor 1340 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1340 may be configured to operate a memory array using a memory controller. In some other cases, a memory controller may be integrated into the at least one processor 1340. The at least one processor 1340 may be configured to execute computer-readable instructions stored in a memory (e.g., the at least one memory 1330) to cause the device 1305 to perform various functions (e.g., functions or tasks supporting enhanced link capacity estimation). For example, the device 1305 or a component of the device 1305 may include at least one processor 1340 and at least one memory 1330 coupled with or to the at least one processor 1340, the at least one processor 1340 and the at least one memory 1330 configured to perform various functions described herein.

In some examples, the at least one processor 1340 may include multiple processors and the at least one memory 1330 may include multiple memories. One or more of the multiple processors may be coupled with one or more of the multiple memories, which may, individually or collectively, be configured to perform various functions described herein. In some examples, the at least one processor 1340 may be a component of a processing system, which may refer to a system (such as a series) of machines, circuitry (including, for example, one or both of processor circuitry (which may include the at least one processor 1340) and memory circuitry (which may include the at least one memory 1330)), or components, that receives or obtains inputs and processes the inputs to produce, generate, or obtain a set of outputs. The processing system may be configured to perform one or more of the functions described herein. For example, the at least one processor 1340 or a processing system including the at least one processor 1340 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code 1335 (e.g., processor-executable code) stored in the at least one memory 1330 or otherwise, to perform one or more of the functions described herein.

The communications manager 1320 may support wireless communications in accordance with examples as disclosed herein. For example, the communications manager 1320 is capable of, configured to, or operable to support a means for transmitting a request for link capacity information associated with a wireless channel for wireless communications between the UE and a network entity. The communications manager 1320 is capable of, configured to, or operable to support a means for receiving a message indicating the link capacity information associated with the wireless channel. The communications manager 1320 is capable of, configured to, or operable to support a means for estimating a link capacity for the wireless channel in accordance with the link capacity information, where subsequent wireless communications are performed in accordance with the estimated link capacity.

By including or configuring the communications manager 1320 in accordance with examples as described herein, the device 1305 may support techniques for an enhanced LCE calculation and update procedure between the UE and the network. The described techniques may use UE-based information, network-signaled information, or both, to update the link capacity estimation operations performed by the UE.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the at least one processor 1340, the at least one memory 1330, the code 1335, or any combination thereof. For example, the code 1335 may include instructions executable by the at least one processor 1340 to cause the device 1305 to perform various aspects of enhanced link capacity estimation as described herein, or the at least one processor 1340 and the at least one memory 1330 may be otherwise configured to, individually or collectively, perform or support such operations.

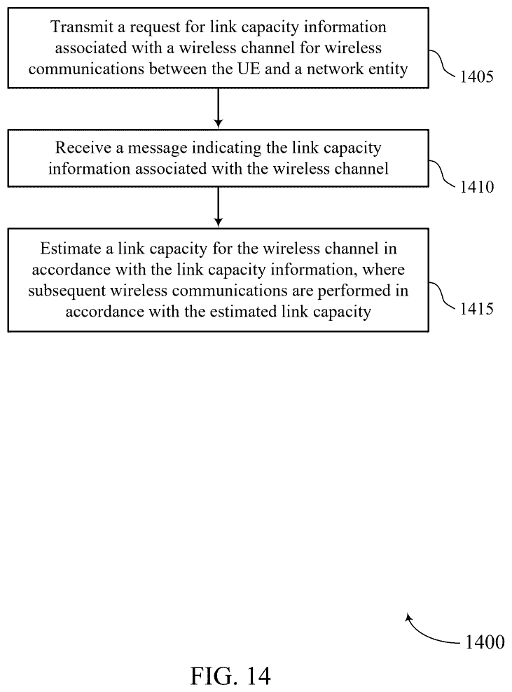

FIG. 14 shows a flowchart illustrating a method 1400 that supports enhanced link capacity estimation in accordance with one or more aspects of the present disclosure. The operations of the method 1400 may be implemented by a UE or its components as described herein. For example, the operations of the method 1400 may be performed by a UE 115 as described with reference to FIGS. 1 through 13. In some examples, a UE may execute a set of instructions to control the functional elements of the UE to perform the described functions. Additionally, or alternatively, the UE may perform aspects of the described functions using special-purpose hardware.

At 1405, the method may include transmitting a request for link capacity information associated with a wireless channel for wireless communications between the UE and a network entity. The operations of 1405 may be performed in accordance with examples as disclosed herein. In some examples, aspects of the operations of 1405 may be performed by a request manager 1225 as described with reference to FIG. 12.

At 1410, the method may include receiving a message indicating the link capacity information associated with the wireless channel. The operations of 1410 may be performed in accordance with examples as disclosed herein. In some examples, aspects of the operations of 1410 may be performed by an LCE manager 1230 as described with reference to FIG. 12.

At 1415, the method may include estimating a link capacity for the wireless channel in accordance with the link capacity information, where subsequent wireless communications are performed in accordance with the estimated link capacity. The operations of 1415 may be performed in accordance with examples as disclosed herein. In some examples, aspects of the operations of 1415 may be performed by an estimation manager 1235 as described with reference to FIG. 12.

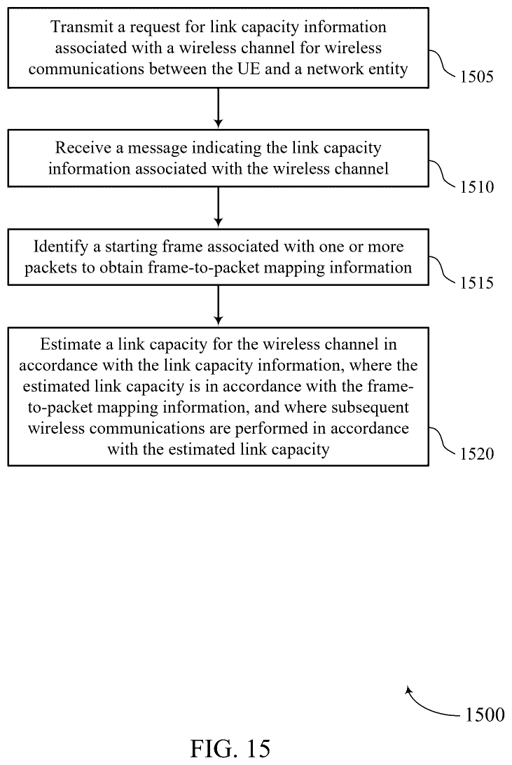

FIG. 15 shows a flowchart illustrating a method 1500 that supports enhanced link capacity estimation in accordance with one or more aspects of the present disclosure. The operations of the method 1500 may be implemented by a UE or its components as described herein. For example, the operations of the method 1500 may be performed by a UE 115 as described with reference to FIGS. 1 through 13. In some examples, a UE may execute a set of instructions to control the functional elements of the UE to perform the described functions. Additionally, or alternatively, the UE may perform aspects of the described functions using special-purpose hardware.

At 1505, the method may include transmitting a request for link capacity information associated with a wireless channel for wireless communications between the UE and a network entity. The operations of 1505 may be performed in accordance with examples as disclosed herein. In some examples, aspects of the operations of 1505 may be performed by a request manager 1225 as described with reference to FIG. 12.

At 1510, the method may include receiving a message indicating the link capacity information associated with the wireless channel. The operations of 1510 may be performed in accordance with examples as disclosed herein. In some examples, aspects of the operations of 1510 may be performed by an LCE manager 1230 as described with reference to FIG. 12.

At 1515, the method may include identifying a starting frame associated with one or more packets to obtain frame-to-packet mapping information. The operations of 1515 may be performed in accordance with examples as disclosed herein. In some examples, aspects of the operations of 1515 may be performed by a frame manager 1240 as described with reference to FIG. 12.

At 1520, the method may include estimating a link capacity for the wireless channel in accordance with the link capacity information, where the estimated link capacity is in accordance with the frame-to-packet mapping information, and where subsequent wireless communications are performed in accordance with the estimated link capacity. The operations of 1520 may be performed in accordance with examples as disclosed herein. In some examples, aspects of the operations of 1520 may be performed by an estimation manager 1235 as described with reference to FIG. 12.

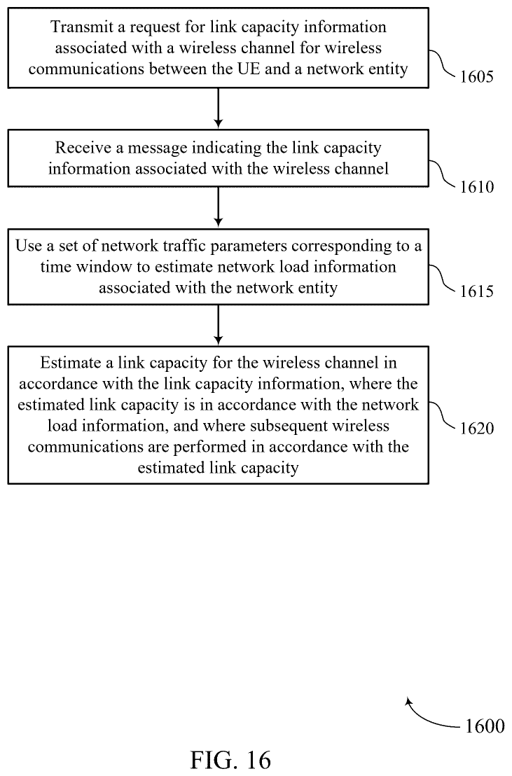

FIG. 16 shows a flowchart illustrating a method 1600 that supports enhanced link capacity estimation in accordance with one or more aspects of the present disclosure. The operations of the method 1600 may be implemented by a UE or its components as described herein. For example, the operations of the method 1600 may be performed by a UE 115 as described with reference to FIGS. 1 through 13. In some examples, a UE may execute a set of instructions to control the functional elements of the UE to perform the described functions. Additionally, or alternatively, the UE may perform aspects of the described functions using special-purpose hardware.

At 1605, the method may include transmitting a request for link capacity information associated with a wireless channel for wireless communications between the UE and a network entity. The operations of 1605 may be performed in accordance with examples as disclosed herein. In some examples, aspects of the operations of 1605 may be performed by a request manager 1225 as described with reference to FIG. 12.

At 1610, the method may include receiving a message indicating the link capacity information associated with the wireless channel. The operations of 1610 may be performed in accordance with examples as disclosed herein. In some examples, aspects of the operations of 1610 may be performed by an LCE manager 1230 as described with reference to FIG. 12.

At 1615, the method may include using a set of network traffic parameters corresponding to a time window to estimate network load information associated with the network entity. The operations of 1615 may be performed in accordance with examples as disclosed herein. In some examples, aspects of the operations of 1615 may be performed by a load manager 1245 as described with reference to FIG. 12.

At 1620, the method may include estimating a link capacity for the wireless channel in accordance with the link capacity information, where the estimated link capacity is in accordance with the network load information, and where subsequent wireless communications are performed in accordance with the estimated link capacity. The operations of 1620 may be performed in accordance with examples as disclosed herein. In some examples, aspects of the operations of 1620 may be performed by an estimation manager 1235 as described with reference to FIG. 12.

The following provides an overview of aspects of the present disclosure:

Aspect 1: A method for wireless communications at a UE, comprising: transmitting a request for link capacity information associated with a wireless channel for wireless communications between the UE and a network entity; receiving a message indicating the link capacity information associated with the wireless channel; and estimating a link capacity for the wireless channel in accordance with the link capacity information, wherein subsequent wireless communications are performed in accordance with the estimated link capacity.

Aspect 2: The method of aspect 1, further comprising: identifying a starting frame associated with one or more packets to obtain frame-to-packet mapping information, wherein the estimated link capacity is in accordance with the frame-to-packet mapping information.

Aspect 3: The method of aspect 2, further comprising: using the frame-to-packet mapping information to estimate a network load associated with the network entity, wherein the estimated link capacity is in accordance with the estimated network load; using the frame-to-packet mapping information to estimate the link capacity within a packet delay budget; and using the frame-to-packet mapping information to estimate a dynamic burst interval parameters, wherein the link capacity is in accordance with a dynamic burst interval parameter.

Aspect 4: The method of any of aspects 2 through 3, wherein the starting frame is identified at a physical layer of the UE using time trace information associated with the one or more packets.

Aspect 5: The method of any of aspects 2 through 4, wherein the starting frame is identified at an application in an application layer of the UE in accordance with the link capacity information.

Aspect 6: The method of any of aspects 1 through 5, further comprising: using a set of network traffic parameters corresponding to a time window to estimate network load information associated with the network entity, wherein the estimated link capacity is in accordance with the network load information.

Aspect 7: The method of aspect 6, further comprising: the link capacity information identifies the set of network traffic parameters corresponding to the time window, a physical layer of the UE estimates the network load information using the link capacity information and outputs the network load information to an application at an application layer of the UE, and the application layer of the UE estimates the link capacity in accordance with the network load information.

Aspect 8: The method of any of aspects 6 through 7, wherein a physical layer of the UE outputs the set of network traffic parameters corresponding to the time window to an application at an application layer of the UE, the application at the application layer of the UE estimates the network load information using the set of network traffic parameters corresponding to the time window, and the application at the application layer of the UE estimates the link capacity in accordance with the network load information.

Aspect 9: The method of any of aspects 1 through 8, further comprising: using, at an AI model, a set of network scheduling parameters associated with the UE to estimate the link capacity.

Aspect 10: The method of aspect 9, wherein the set of network scheduling parameters are output from a physical layer of the UE to the AI model, the estimated link capacity is output from the AI model to an application at an application layer of the UE, and the application uses the estimated link capacity for rate control adaptation operations for the subsequent wireless communications.

Aspect 11: The method of any of aspects 1 through 10, further comprising: using the link capacity information and a set of metrics associated with the subsequent wireless communications to estimate the link capacity.

Aspect 12: The method of aspect 11, wherein the set of metrics comprise one or more of a frame-to-packet mapping information, a set of traffic metrics associated with the subsequent wireless communications, and a QoS metric associated with the subsequent wireless communications.

Aspect 13: The method of any of aspects 11 through 12, wherein an application at an application layer of the UE uses the link capacity information obtained from a physical layer of the UE and a legacy-based link capacity estimation to estimate the link capacity, and the application at the application layer uses the estimated link capacity for rate control adaptation operations associated with the subsequent wireless communications in accordance with the set of metrics.

Aspect 14: The method of any of aspects 1 through 13, further comprising: transmitting a UE capability message indicating support for link capacity estimation in accordance with one or more types of link capacity information.

Aspect 15: The method of any of aspects 1 through 14, further comprising: receiving information identifying one or more threshold-based or event-based conditions associated with the UE transmitting the request for the link capacity information.

Aspect 16: The method of aspect 15, wherein receiving the message is in accordance with an occurrence of at least one of the one or more threshold-based or event-based conditions.

Aspect 17: An apparatus for wireless communications at a UE, comprising one or more processors, one or more memories coupled with the one or more processors, and one or more processor-readable instructions stored in the one or more memories and executable by the one or more processors to individually or collectively to cause the apparatus to perform a method of any of aspects 1 through 16.

Aspect 18: A UE for wireless communications, comprising at least one means for performing a method of any of aspects 1 through 16.

Aspect 19: A non-transitory computer-readable medium storing code for wireless communications, the code comprising instructions executable by one or more processors to perform a method of any of aspects 1 through 16.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
one or more processors;
one or more memories coupled with the one or more processors; and
one or more processor-readable instructions stored in the one or more memories and executable by the one or more processors individually or collectively to cause the apparatus to:
transmit a request for link capacity information associated with a wireless channel for wireless communications between the UE and a network entity;
receive a message indicating the link capacity information associated with the wireless channel; and
estimate a link capacity for the wireless channel in accordance with the link capacity information, wherein subsequent wireless communications are performed in accordance with the estimated link capacity.

2. The apparatus of claim 1, wherein the instructions are executable by the one or more processors individually or collectively to cause the apparatus to:
identify a starting frame associated with one or more packets to obtain frame-to-packet mapping information, wherein the estimated link capacity is in accordance with the frame-to-packet mapping information.

3. The apparatus of claim 2, wherein the instructions are executable by the one or more processors individually or collectively to cause the apparatus to:
use the frame-to-packet mapping information to estimate a network load associated with the network entity, wherein the estimated link capacity is in accordance with the estimated network load;
use the frame-to-packet mapping information to estimate the link capacity within a packet delay budget; and
use the frame-to-packet mapping information to estimate a dynamic burst interval parameters, wherein the link capacity is in accordance with a dynamic burst interval parameter.

4. The apparatus of claim 2, wherein the instructions are executable by the one or more processors individually or collectively to cause the apparatus to identify the starting frame at a physical layer of the UE using time trace information associated with the one or more packets.

5. The apparatus of claim 2, wherein the instructions are executable by the one or more processors individually or collectively to cause the apparatus to identify the starting frame at an application in an application layer of the UE in accordance with the link capacity information.

6. The apparatus of claim 1, wherein the one or more processors individually or collectively to cause the apparatus to:
use a set of network traffic parameters corresponding to a time window to estimate network load information associated with the network entity, wherein the estimated link capacity is in accordance with the network load information.

7. The apparatus of claim 6, wherein:
the link capacity information identifies the set of network traffic parameters corresponding to the time window;
the instructions are executable by the one or more processors individually or collectively to cause a physical layer of the UE to estimate the network load information using the link capacity information and output the network load information to an application at an application layer of the UE; and
the instructions are executable by the one or more processors individually or collectively to cause the application layer of the UE to estimate the link capacity in accordance with the network load information.

8. The apparatus of claim 6, wherein:
the instructions are executable by the one or more processors individually or collectively to cause a physical layer of the UE to output the set of network traffic parameters corresponding to the time window to an application at an application layer of the UE;
the instructions are executable by the one or more processors individually or collectively to cause the application at the application layer of the UE to:
estimate the network load information using the set of network traffic parameters corresponding to the time window; and
estimate the link capacity in accordance with the network load information.

9. The apparatus of claim 1, wherein the instructions are executable by the one or more processors individually or collectively to cause the apparatus to:
use, at an artificial intelligence (AI) model, a set of network scheduling parameters associated with the UE to estimate the link capacity.

10. The apparatus of claim 9, wherein the instructions are executable by the one or more processors individually or collectively to cause the apparatus to:
output the set of network scheduling parameters from a physical layer of the UE to the AI model;
output the estimated link capacity from the AI model to an application at an application layer of the UE; and
use, by the application, the estimated link capacity for rate control adaptation operations for the subsequent wireless communications.

11. The apparatus of claim 1, wherein the one or more processors individually or collectively to cause the apparatus to:
use the link capacity information and a set of metrics associated with the subsequent wireless communications to estimate the link capacity.

12. The apparatus of claim 11, wherein the set of metrics comprise one or more of a frame-to-packet mapping information, a set of traffic metrics associated with the subsequent wireless communications, and a quality-of-service (QoS) metric associated with the subsequent wireless communications.

13. The apparatus of claim 11, wherein:
the instructions are executable by the one or more processors individually or collectively to cause an application at an application layer of the UE to use the link capacity information obtained from a physical layer of the UE and a legacy-based link capacity estimation to estimate the link capacity; and
the instructions are executable by the one or more processors individually or collectively to cause the application at the application layer to use the estimated link capacity for rate control adaptation operations associated with the subsequent wireless communications in accordance with the set of metrics.

14. The apparatus of claim 1, wherein the instructions are executable by the one or more processors individually or collectively to cause the apparatus to:
transmit a UE capability message indicating support for link capacity estimation in accordance with one or more types of link capacity information.

15. The apparatus of claim 1, wherein the instructions are executable by the one or more processors individually or collectively to cause the apparatus to:
receive information identifying one or more threshold-based or event-based conditions associated with the UE transmitting the request for the link capacity information.

16. The apparatus of claim 15, wherein the instructions are executable by the one or more processors individually or collectively to cause the apparatus to receive the message in accordance with an occurrence of at least one of the one or more threshold-based or event-based conditions.

17. A method for wireless communications at a user equipment (UE), comprising:
transmitting a request for link capacity information associated with a wireless channel for wireless communications between the UE and a network entity;
receiving a message indicating the link capacity information associated with the wireless channel; and
estimating a link capacity for the wireless channel in accordance with the link capacity information, wherein subsequent wireless communications are performed in accordance with the estimated link capacity.

18. The method of claim 17, further comprising:
identifying a starting frame associated with one or more packets to obtain frame-to-packet mapping information, wherein the estimated link capacity is in accordance with the frame-to-packet mapping information.

19. The method of claim 18, further comprising:
using the frame-to-packet mapping information to estimate a network load associated with the network entity, wherein the estimated link capacity is in accordance with the estimated network load;
using the frame-to-packet mapping information to estimate the link capacity within a packet delay budget; and
using the frame-to-packet mapping information to estimate a dynamic burst interval parameters, wherein the link capacity is in accordance with a dynamic burst interval parameter.

20. The method of claim 18, wherein the starting frame is identified at a physical layer of the UE using time trace information associated with the one or more packets.

21. The method of claim 18, wherein the starting frame is identified at an application in an application layer of the UE in accordance with the link capacity information.

22. The method of claim 17, further comprising:
using a set of network traffic parameters corresponding to a time window to estimate network load information associated with the network entity, wherein the estimated link capacity is in accordance with the network load information.

23. The method of claim 22, wherein:
the link capacity information identifies the set of network traffic parameters corresponding to the time window,
a physical layer of the UE estimates the network load information using the link capacity information and outputs the network load information to an application at an application layer of the UE, and
the application layer of the UE estimates the link capacity in accordance with the network load information.

24. The method of claim 22, wherein:
a physical layer of the UE outputs the set of network traffic parameters corresponding to the time window to an application at an application layer of the UE,
the application at the application layer of the UE estimates the network load information using the set of network traffic parameters corresponding to the time window, and
the application at the application layer of the UE estimates the link capacity in accordance with the network load information.

25. The method of claim 17, further comprising:
using, at an artificial intelligence (AI) model, a set of network scheduling parameters associated with the UE to estimate the link capacity.

26. The method of claim 25, wherein:
the set of network scheduling parameters are output from a physical layer of the UE to the AI model,
the estimated link capacity is output from the AI model to an application at an application layer of the UE, and
the application uses the estimated link capacity for rate control adaptation operations for the subsequent wireless communications.

27. The method of claim 17, further comprising:
using the link capacity information and a set of metrics associated with the subsequent wireless communications to estimate the link capacity.

28. The method of claim 27, wherein:
an application at an application layer of the UE uses the link capacity information obtained from a physical layer of the UE and a legacy-based link capacity estimation to estimate the link capacity, and
the application at the application layer uses the estimated link capacity for rate control adaptation operations associated with the subsequent wireless communications in accordance with the set of metrics.

29. An apparatus for wireless communications at a user equipment (UE), comprising:
means for transmitting a request for link capacity information associated with a wireless channel for wireless communications between the UE and a network entity;
means for receiving a message indicating the link capacity information associated with the wireless channel; and
means for estimating a link capacity for the wireless channel in accordance with the link capacity information, wherein subsequent wireless communications are performed in accordance with the estimated link capacity.

30. A non-transitory computer-readable medium storing code for wireless communications, the code comprising instructions executable by one or more processors to:
transmit a request for link capacity information associated with a wireless channel for wireless communications between a user equipment (UE) and a network entity;
receive a message indicating the link capacity information associated with the wireless channel; and
estimate a link capacity for the wireless channel in accordance with the link capacity information, wherein subsequent wireless communications are performed in accordance with the estimated link capacity.
